(19) United States
(12) Patent Application Publication
(10) Pub. No.: US 2026/0022235 A1
(43) Pub. Date: Jan. 22, 2026

(54) RUBBER COMPOSITION FOR TIRE TREAD AND TIRE

(71) Applicant: Toyo Tire Corporation, Itami-shi (JP)

(72) Inventor: Yuma Nishikawa, Itami-shi (JP)

(73) Assignee: Toyo Tire Corporation, Itami-shi (JP)

(21) Appl. No.: 19/256,306

(22) Filed: Jul. 1, 2025

(30) Foreign Application Priority Data
Jul. 22, 2024 (JP) 2024-117082

(51) Int. Cl. C08L 15/00; B60C 1/00; C08K 3/36; C08L 7/00

(52) U.S. Cl. CPC C08L 15/00; B60C 1/0016; C08K 3/36; C08L 7/00; C08K 2201/006; C08L 2205/025; C08L 2205/035

(57) ABSTRACT

The rubber composition for a tire tread according to an embodiment contains a rubber component containing a natural rubber and a styrene butadiene rubber and silica having a CTAB adsorption specific surface area of less than 200 m²/g. The amount of the natural rubber in 100 parts by mass of the rubber component is more than 40 parts by mass and less than 75 parts by mass. The styrene content in the rubber component except for the natural rubber is 21 mass % or less. The amount of the silica is more than 55 parts by mass and less than 90 parts by mass based on 100 parts by mass of the rubber component.

### BACKGROUND OF THE INVENTION

### 1. Field of the Invention

The present invention relates to a rubber composition for a tire tread and a tire using the same.

### 2. Description of Related Art

Various proposals have been made to improve the chipping resistance performance of a tire. Chipping here means that the lands such as the blocks formed on the tread surface chip, and it is required to suppress such chipping.

For example, JP2021-070778A discloses a rubber composition in which the chipping resistance performance is improved without impairing the driving stability by blending a thermoplastic resin obtained by copolymerizing styrene, indene, and dicyclopentadiene in a diene rubber containing a natural rubber together with specific carbon black.

JP2024-027437A discloses a rubber composition which improves the abrasion resistance performance of the tire and in which the cut resistance performance and the chipping resistance performance are improved by blending a rubber additive containing a specific sulfur-containing hydrocarbon polymer in a rubber component containing 50 mass % or more of an isoprene rubber and having a glass transition temperature of −90° C. or higher and lower than −50° C.

JP2024-002911A discloses that the chipping resistance performance is improved by adding 40 to 60 parts by mass of a styrene butadiene rubber having a styrene content of 25 mass % or less in 100 parts by mass of a rubber component, adding 30 parts by mass or less of an isoprene rubber, and adding 100 parts by mass or less of silica as a filler based on 100 parts by mass of the rubber component.

### SUMMARY OF THE INVENTION

For example, for an off-road tire, chipping resistance performance and tear resistance performance are required. It has been difficult to maintain abrasion resistance performance and low rolling resistance performance (low fuel efficiency performance) while securing the performances above.

In view of the above point, an object of the embodiment of the invention is to provide a rubber composition for a tire tread having excellent chipping resistance performance, excellent tear resistance performance, excellent abrasion resistance performance, and excellent low rolling resistance performance and to provide a tire using the same.

The invention includes the embodiments shown below.
[1] A rubber composition for a tire tread containing a rubber component containing a natural rubber and a styrene butadiene rubber and silica having a CTAB adsorption specific surface area of less than 200 m²/g in which the amount of the natural rubber in 100 parts by mass of the rubber component is more than 40 parts by mass and less than 75 parts by mass, the styrene content in the rubber component except for the natural rubber is 21 mass % or less, and the amount of the silica is more than 55 parts by mass and less than 90 parts by mass based on 100 parts by mass of the rubber component.
[2] The rubber composition for a tire tread according to [1] in which 100 parts by mass of the rubber component contain more than 40 parts by mass and 60 parts by mass or less of the natural rubber, 15 parts by mass or more and less than 60 parts by mass of the styrene butadiene rubber, and 0 parts by mass or more and less than 45 parts by mass of a butadiene rubber.
[3] The rubber composition for a tire tread according to [1] or [2] in which the styrene butadiene rubber contains a modified styrene butadiene rubber.
[4] The rubber composition for a tire tread according to any one of [1] to [3] in which the amount of the silica is 60 to 75 parts by mass based on 100 parts by mass of the rubber component.
[5] A tire having a tread formed with the rubber composition for a tire tread according to any one of [1] to [4].

According to the embodiment of the invention, a rubber composition for a tire tread having excellent chipping resistance performance, excellent tear resistance performance, excellent abrasion resistance performance, and excellent low rolling resistance performance and a tire using the same can be provided.

### DESCRIPTION OF EMBODIMENTS

In the rubber composition for a tire tread (also simply called “rubber composition” below) according to the embodiment, the rubber component contains a natural rubber (NR) and a styrene butadiene rubber (SBR).

The natural rubber is not particularly limited. Examples thereof include a ribbed smoked sheet (RSS), technically specified rubber (TSR), natural rubber latex, and the like, and the natural rubber may also be a modified rubber thereof, for example, a modified natural rubber such as an epoxidized natural rubber. As the natural rubber, a modified natural rubber and an unmodified natural rubber may be used in combination.

The styrene butadiene rubber may be a solution-polymerized styrene butadiene rubber (SSBR) or an emulsion-polymerized styrene butadiene rubber (ESBR). The styrene butadiene rubber may be a modified styrene butadiene rubber in which the terminal, the main chain, or the like has been modified (modified SBR) or an unmodified styrene butadiene rubber without modification (unmodified SBR), or modified SBR and unmodified SBR may be used in combination. The styrene butadiene rubber preferably contains modified SBR and more preferably contains a modified solution-polymerized styrene butadiene rubber (modified SSBR). In this case, 100 mass % of the SBR preferably contains modified SBR (preferably modified SSBR) at 50 mass % or more, more preferably 60 mass % or more, further preferably 80 mass % or more, and the content thereof may be 100 mass %.

As the modified SBR, SBR which has been modified with a functional group by introducing the functional group to the terminal and/or the main chain is used. The functional group preferably contains an oxygen atom and/or a nitrogen atom, and examples thereof include at least one selected from the group consisting of an amino group, a hydroxy group, an alkoxy group, an alkoxysilyl group, an epoxy group, and a carboxy group. When modified SBR having such a functional group is used, the effect of improving the dispersibility of silica can be enhanced.

In the embodiment, the rubber component contains more than 40 mass % and less than 75 mass % of the natural rubber. That is, the amount of the natural rubber in 100 parts by mass of the rubber component is more than 40 parts by mass and less than 75 parts by mass. Moreover, the styrene content (bound styrene content) in the rubber component except for the natural rubber is 21 mass % or less. When a relatively high amount of natural rubber is contained in the rubber component in this manner, the chipping resistance performance and the tear resistance performance can be improved. When the styrene content in the rubber component except for the natural rubber (also called “other rubber component X” below) is 21 mass % or less, the balance of the abrasion resistance performance and the low rolling resistance performance can be improved. Although the reason is not intended to be limited thereto, it is believed that, when the styrene content is low, the miscibility of the other rubber component X and the natural rubber improves, and the low rolling resistance performance and the abrasion resistance performance can be improved while the chipping resistance performance and the tear resistance performance are secured.

As described above, the other rubber component X contains the styrene butadiene rubber. Accordingly, the other rubber component X contains a styrene unit. In the embodiment, the other rubber component X is composed of one rubber or a combination of rubbers in such a manner that the styrene content of the other rubber component X becomes 21 mass % or less. The styrene content of the other rubber component X is preferably 1 to 21 mass %, more preferably 2 to 20 mass %, further preferably 5 to 18 mass %.

The styrene content of the other rubber component X is the total styrene unit content (mass %) contained in the total amount of the other rubber component X and is calculated by Σ (each rubber X_{A} content (mass %) x styrene content (mass %) of each rubber X_{A}/100). Here, the content (mass %) of each rubber X_{A} is the mass proportion of each rubber X_{A} constituting the other rubber component X in 100 mass % of the other rubber component X. The styrene content (mass %) of each rubber X_{A} is determined by 1H-NMR.

The other rubber component X may be composed of the styrene butadiene rubber alone or may contain another diene rubber together with the styrene butadiene rubber. Here, the diene rubber refers to a rubber having a repeating unit corresponding to a diene monomer having a conjugated double bond and contains a carbon-carbon double bond in the main chain of the polymer.

Specific examples of the other diene rubber include a synthetic isoprene rubber (IR), a butadiene rubber (BR), a nitrile rubber (NBR), a chloroprene rubber (CR), a styrene-isoprene copolymer rubber, a butadiene-isoprene copolymer rubber, and the like. Of these, the other diene rubber is preferably a butadiene rubber, and thus the rubber component may contain the natural rubber, the styrene butadiene rubber, and the butadiene rubber.

In an embodiment, 100 parts by mass of the rubber component may contain more than 40 parts by mass and less than 75 parts by mass of the natural rubber, 15 parts by mass or more and less than 60 parts by mass of the styrene butadiene rubber, and 0 parts by mass or more and less than 45 parts by mass of the butadiene rubber. Here, the butadiene rubber is an optional component. Preferably, 100 parts by mass of the rubber component contain more than 40 parts by mass and 60 parts by mass or less of the natural rubber, 15 parts by mass or more and less than 60 parts by mass of the styrene butadiene rubber, and 0 parts by mass or more and less than 45 parts by mass of the butadiene rubber. More preferably, 100 parts by mass of the rubber component contain 42 parts by mass or more and 60 parts by mass or less of the natural rubber, 16 parts by mass or more and 58 parts by mass or less of the styrene butadiene rubber, and 0 parts by mass or more and 42 parts by mass or less of the butadiene rubber. Hundred parts by mass of the rubber component may contain 42 to 60 parts by mass of the natural rubber, 20 to 48 parts by mass of the styrene butadiene rubber, and 0 to 30 parts by mass of the butadiene rubber. Here, 100 parts by mass of the rubber component may contain 10 parts by mass or more of the butadiene rubber.

The total amount of the natural rubber and the styrene butadiene rubber in 100 parts by mass of the rubber component is preferably 55 parts by mass or more, more preferably 70 parts by mass or more, further preferably 80 parts by mass or more.

The rubber composition according to the embodiment contains silica having a CTAB adsorption specific surface area of less than 200 m²/g. By blending silica having such a small CTAB adsorption specific surface area, the low rolling resistance performance and the tear resistance performance can be improved. The silica may be wet silica, dry silica, or the like, and wet silica such as wet-precipitated silica and wet-gelled silica is preferably used. The lower limit of the CTAB adsorption specific surface area of the silica is not particularly limited but is, for example, preferably 100 m²/g or more to improve the stiffness for use in an off-road tire. The CTAB adsorption specific surface area of the silica is preferably 105 to 190 m²/g, more preferably 150 to 180 m²/g, further preferably 160 to 170 m²/g. The CTAB (cetyltrimethylammonium bromide) adsorption specific surface area of the silica is measured in accordance with JIS K6430:2008, attachment G.

The amount of the silica in the rubber composition is more than 55 parts by mass and less than 90 parts by mass based on 100 parts by mass of the rubber component. When the amount of the silica exceeds 55 parts by mass, the abrasion resistance performance and the tear resistance performance can be improved. When the amount of the silica is less than 90 parts by mass, the abrasion resistance performance and the low rolling resistance performance can be improved. The amount of the silica, based on 100 parts by mass of the rubber component, is preferably 60 to 85 parts by mass, more preferably 60 to 80 parts by mass, further preferably 60 to 75 parts by mass.

The rubber composition according to the embodiment may contain a silane coupling agent. Examples of the silane coupling agent include a sulfide-silane coupling agent and a mercapto silane coupling agent. The silane coupling agent content is not particularly limited and may be, for example, based on 100 parts by mass of the silica, five to 20 parts by mass or five to 15 parts by mass.

In the rubber composition according to the embodiment, the filler may be silica alone, but another filler may be blended with silica. As the other filler, carbon black is preferably used. The proportion of the silica in the filler is preferably 60 mass % or more, more preferably 70 mass % or more, further preferably 80 mass % or more.

When the rubber composition contains carbon black, the carbon black content is not particularly limited but is, based on 100 parts by mass of the rubber component, preferably 30 parts by mass or less, more preferably 20 parts by mass or less, further preferably three to 15 parts by mass, and may be three to 10 parts by mass.

The rubber composition according to the embodiment may further contain a thermoplastic resin. The thermoplastic resin blended in the rubber composition is also called a tackifying resin and can enhance the effect of improving the chipping resistance performance and the tear resistance performance. The thermoplastic resin is not particularly limited but is preferably a thermoplastic resin having a softening point of 50 to 150° C., and the softening point is more preferably 70 to 120° C. The softening point of the resin is measured in accordance with JIS K6220-1:2015 using a ring-and-ball softening point tester.

Specific examples of the thermoplastic resin include a petroleum resin (for example, C5 petroleum resin, C9 petroleum resin, and C5/C9 petroleum resin), a styrene-based resin, a terpene-based resin (for example, polyterpene resin and terpene phenolic resin), a coumarone-based resin (for example, coumarone resin and coumarone-indene resin), a rosin-based resin (for example, natural resin rosin and rosin modified maleic resin), and the like, and any one kind thereof or a combination of two or more kinds thereof may be used.

The thermoplastic resin content is not particularly limited and may be, based on 100 parts by mass of the rubber component, 0.5 to 20 parts by mass, one to 15 parts by mass, two to 10 parts by mass, or two to seven parts by mass. An additive which is generally used for a rubber composition, such as an oil, zinc oxide, stearic acid, an antioxidant, a wax, a vulcanizing agent, and a vulcanization accelerator, can be blended in the rubber composition according to the embodiment in addition to the above components.

Examples of the oil include mineral oils such as paraffin oil, naphthenic oil, and aroma oil, vegetable oils such as linseed oil, safflower oil, soybean oil, corn oil, castor oil, rapeseed oil, and cottonseed oil, and the like. Any one kind thereof or a combination of two or more kinds thereof can be used. The oil content is not particularly limited and may be, for example, based on 100 parts by mass of the rubber component, 0 to 100 parts by mass, 10 to 50 parts by mass, or 15 to 35 parts by mass.

The zinc oxide content is not particularly limited and may be, for example, based on 100 parts by mass of the rubber component, 0 to 10 parts by mass, 0.5 to five parts by mass, or one to four parts by mass.

The stearic acid content is not particularly limited and may be, for example, based on 100 parts by mass of the rubber component, 0 to 10 parts by mass, 0.5 to five parts by mass, or one to four parts by mass.

Examples of the antioxidant include various antioxidants such as amine-ketone-based, aromatic secondary amine-based, monophenol-based, bisphenol-based, and benzimidazole-based antioxidants, and any one kind thereof or a combination of two or more kinds thereof can be used. The antioxidant content is not particularly limited and may be, for example, based on 100 parts by mass of the rubber component, 0 to 10 parts by mass, 0.5 to five parts by mass, or one to four parts by mass.

The wax content is not particularly limited and may be, for example, based on 100 parts by mass of the rubber component, 0 to 10 parts by mass, 0.5 to five parts by mass, or one to four parts by mass.

As the vulcanizing agent, sulfur is preferably used. The vulcanizing agent content is not particularly limited and may be, based on 100 parts by mass of the rubber component, 0.1 to 10 parts by mass, 0.5 to five parts by mass, or one to three parts by mass.

Examples of the vulcanization accelerator include various vulcanization accelerators such as sulfenamide-based, guanidine-based, thiuram-based, and thiazole-based vulcanization accelerators, and any one kind thereof alone or a combination of two or more kinds thereof can be used. The vulcanization accelerator content is not particularly limited and may be, based on 100 parts by mass of the rubber component, 0.1 to 10 parts by mass, one to seven parts by mass, or two to five parts by mass.

The rubber composition according to the embodiment can be produced by kneading using a generally used mixer such as a Banbury mixer, a kneader, and a roll according to a general method. That is, for example, by adding and mixing the additives excluding the vulcanizing agent and the vulcanization accelerator in the rubber component in a first mixing stage and next adding and mixing the vulcanizing agent and the vulcanization accelerator in the obtained mixture in a final mixing stage, a rubber composition can be prepared.

The rubber composition according to the embodiment can be used for the tread of a tire. Examples of the tire include pneumatic tires of various sizes for various applications, such as tires of passenger vehicles and large-sized tires of trucks and buses. Preferably, the rubber composition is used for the tread of an off-road tire such as mud terrain (M/T) and all terrain (A/T) tires.

The tire according to an embodiment has a tread produced using the rubber composition. That is, the tire according to an embodiment has a tread rubber formed with the rubber composition. The structures of the tread rubber of a tire include a two-layer structure having a cap rubber and a base rubber and a single-layer structure in which both are combined. In the single-layer structure, the tread rubber may be formed with the rubber composition. In the two-layer structure, although the cap rubber on the outer side which comes into contact with the road surface is preferably formed with the rubber composition, the base rubber placed inside the cap rubber may be formed with the rubber composition, and both the cap rubber and the base rubber may be formed with the rubber composition.

The production method of the tire is not particularly limited. For example, the rubber composition is formed into a predetermined form by extrusion processing according to a general method, and an unvulcanized tread rubber member is obtained. By assembling the tread rubber member with other tire members, an unvulcanized tire (green tire) is produced. Then, for example, by vulcanizing and forming at 140° C. to 180° C., a tire can be produced.

### Examples

Examples of the invention are shown below, but the invention is not limited to these Examples.

The components used in the Examples and the Comparative Examples are as follows.
NR: RSS #3
SBR-1: unmodified ESBR, styrene content=23.5 mass %, “SBR1502” manufactured by ENEOS Materials Corporation
SBR-2: terminal-modified SSBR, styrene content=20.5 mass %, “HPR350” manufactured by ENEOS Materials Corporation
SBR-3: terminal-modified SSBR, styrene content=10 mass %, “HPR840” manufactured by ENEOS Materials Corporation
BR: “BR150B” manufactured by UBE
Carbon black: “Seast 3” manufactured by TOKAI CARBON CO., LTD.
Silica-1: “Ultrasil VN3” manufactured by Evonik Industries, CTAB=167 m²/g:
Silica-2: “Ultrasil 9100GR” manufactured by Evonik Industries, CTAB=200 m²/g
Silica-3: “Ultrasil 5000GR” manufactured by Evonik Industries, CTAB=110 m²/g
Silane coupling agent: “Si69” manufactured by Evonik Industries.
Oil: “Process NC-140” manufactured by ENEOS Corporation
Zinc oxide: “Zinc Oxide, Type 2” manufactured by MITSUI MINING & SMELTING CO., LTD.
Stearic acid: “Lunac S-20” manufactured by Kao Corporation
Antioxidant: “Nocrac 6C” manufactured by OUCHI SHINKO CHEMICAL INDUSTRIAL CO., LTD.
Wax: “OZOACE0355” manufactured by NIPPON SEIRO CO., LTD.
Resin: C5/C9 petroleum resin (aliphatic/aromatic copolymer hydrocarbon resin), “Petrotack 90” manufactured by Tosoh Corporation, softening point=95° C.
Sulfur: “Powder Sulfur” manufactured by Tsurumi Chemical Industry Co., ltd.
Vulcanization accelerator CZ: “Soxinol CZ” manufactured by Sumitomo Chemical Co., Ltd.
Vulcanization accelerator DPG: “Nocceler D” manufactured by OUCHI SHINKO CHEMICAL INDUSTRIAL CO., LTD.

Rubber compositions were prepared according to the formulations (parts by mass) shown in Tables 1 to 3 below using a Banbury mixer. Specifically, the agents to be added excluding sulfur and the vulcanization accelerators were first added to and kneaded in the rubber component in a first mixing stage (discharge temperature =155° C.). Next, sulfur and the vulcanization accelerators were added to and kneaded in the obtained kneaded material in a final mixing stage (discharge temperature=90° C.), and an unvulcanized rubber composition was thus prepared. Here, “St (%) in X” in the tables is the styrene content (mass %) in the other rubber component X.

The low rolling resistance performance, the abrasion resistance performance, the chipping resistance performance, and the tear resistance performance of each obtained rubber composition were evaluated. The evaluation methods are as follows.

### [Low Rolling Resistance Performance]

A pneumatic radial tire for testing (tire size: 215/45ZR17) was produced using the rubber composition for the tread rubber by vulcanizing and forming according to a general method. The rolling resistance of the obtained tire for testing was measured using a rolling resistance-measuring drum tester under the conditions of an air pressure of 230 kPa, a load of 450 kgf (4.4 kN), a temperature of 23° C., and 80 km/h. The reciprocal of the rolling resistance was expressed with an index, where the value of Comparative Example 1 was regarded as 100. As the index becomes larger, the rolling resistance becomes smaller, meaning that the low rolling resistance performance (low fuel efficiency performance) is excellent.

### [Abrasion Resistance Performance]

A rubber sample was produced by vulcanizing the rubber composition at 160° C. for 30 minutes. The abrasion amount of the rubber sample was measured in accordance with JIS K6264-2:2005 using a Lambourn abrasion tester at a load of 3 kg, a slip rate of 24%, a temperature of 23° C., and a falling sand rate of 20 g/minute. The reciprocal of the abrasion amount was expressed with an index, where the value of Comparative Example 1 was regarded as 100. As the index becomes larger, the abrasion amount becomes smaller, meaning that the abrasion resistance performance is excellent.

### [Chipping Resistance Performance]

The tensile product was determined by a tensile test in accordance with JIS K6251:2017. Specifically, a rubber sample (type 3 dumbbell sample, thickness of 2.0 mm) was produced by vulcanizing the rubber composition at 160° C. for 30 minutes. The elongation at break Eb (%) and the tensile strength T (MPa) of the rubber sample were measured by a tensile test (speed: 500 mm/minute). The tensile product, which is the product of the elongation at break and the tensile strength (Eb×T), was determined and expressed with an index, where the value of Comparative Example 1 was regarded as 100. As the index becomes larger, the tensile product becomes larger, meaning that the chipping resistance performance is excellent.

### [Tear Resistance Performance]

The tear strength was measured in accordance with JIS K6252-1:2015. Specifically, a rubber sample (crescent shape, thickness of 2.0 mm) was produced by vulcanizing the rubber composition at 160° C. for 30 minutes. The tear strength of the rubber sample was determined by a tensile test (speed: 500 mm/minute) and expressed with an index, where the value of Comparative Example 1 was regarded as 100. As the index becomes larger, the tear strength becomes larger, meaning that the tear resistance performance is excellent.

TABLE 1

| | Comp. | Comp. | Comp | Comp. | Comp. | Comp. | Comp. | Comp. | Comp. | Comp. |
|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 |
| Formulation | | | | | | | | | | |
| (parts by mass) | | | | | | | | | | |
| NR | 42 | 42 | 60 | 70 | 70 | 40 | 75 | 75 | 42 | 42 |
| SBR-1 | 16 | | 15 | 10 | 10 | 20 | | | | |
| SBR-2 | 42 | | 25 | | | | 15 | 15 | 58 | 58 |
| SBR-3 | | | | 20 | 20 | 40 | | | | |
| BR | | 58 | | | | | 10 | 10 | | |
| Carbon black | 10 | 10 | 10 | 5 | 5 | 10 | 10 | 10 | 25 | 10 |
| Silica-1 | 70 | 70 | 70 | 90 | 90 | 70 | 70 | 70 | 55 | |
| Silica-2 | | | | | | | | | | 70 |
| Silica-3 | | | | | | | | | | |
| Silane coupling | 7 | 7 | 7 | 9 | 9 | 7 | 7 | 7 | 6 | 7 |
| agent | | | | | | | | | | |
| Oil | 25 | 25 | 25 | 35 | 30 | 20 | 20 | 20 | 25 | 25 |
| Zinc oxide | 2 | 2 | 2 | 2 | 2 | 2 | 2 | 2 | 2 | 2 |
| Stearic acid | 2 | 2 | 2 | 2 | 2 | 2 | 2 | 2 | 2 | 2 |
| Antioxidant | 2 | 2 | 2 | 2 | 2 | 2 | 2 | 2 | 2 | 2 |
| Wax | 2 | 2 | 2 | 2 | 2 | 2 | 2 | 2 | 2 | 2 |
| Resin | | | | | 5 | | | 5 | | |
| Sulfur | 2.0 | 2.0 | 2.0 | 2.0 | 2.0 | 2.0 | 2.0 | 2.0 | 2.0 | 2.0 |
| Vulcanization | 1.5 | 1.5 | 1.5 | 1.5 | 1.5 | 1.5 | 1.5 | 1.5 | 1.5 | 1.5 |
| accelerator CZ | | | | | | | | | | |
| Vulcanization | 1.0 | 1.0 | 1.0 | 1.0 | 1.0 | 1.0 | 1.0 | 1.0 | 1.0 | 1.0 |
| accelerator DPG | | | | | | | | | | |
| St (%) in X | 21.3 | 0.0 | 21.6 | 14.5 | 14.5 | 14.5 | 12.3 | 12.3 | 20.5 | 20.5 |
| Evaluation (index) | | | | | | | | | | |
| Low rolling | 100 | 100 | 98 | 97 | 95 | 100 | 98 | 96 | 108 | 95 |
| resistance | | | | | | | | | | |
| performance | | | | | | | | | | |
| Abrasion resistance | 100 | 108 | 89 | 84 | 88 | 104 | 94 | 95 | 98 | 101 |
| performance | | | | | | | | | | |
| Chipping resistance | 100 | 90 | 114 | 95 | 100 | 97 | 118 | 120 | 109 | 105 |
| performance | | | | | | | | | | |
| Tear resistance | 100 | 94 | 108 | 112 | 114 | 106 | 110 | 114 | 86 | 96 |
| performance | | | | | | | | | | |

TABLE 2

| | Ex. 1 | Ex. 2 | Ex. 3 | Ex. 4 | Ex. 5 | Ex. 6 | Ex. 7 |
|---|---|---|---|---|---|---|---|
| Formulation | | | | | | | |
| (parts by mass) | | | | | | | |
| NR | 42 | 42 | 42 | 42 | 60 | 60 | 60 |
| SBR-1 | | | | | | | |
| SBR-2 | 58 | 42 | | | 25 | | |
| SBR-3 | | 16 | 42 | 16 | | 25 | 25 |
| BR | | | 16 | 42 | 15 | 15 | 15 |
| Carbon black | 10 | 10 | 10 | 10 | 10 | 10 | 10 |
| Silica-1 | 70 | 70 | 70 | 70 | 70 | 70 | 60 |
| Silica-2 | | | | | | | |
| Silica-3 | | | | | | | |
| Silane coupling agent | 7 | 7 | 7 | 7 | 7 | 7 | 7 |
| Oil | 25 | 25 | 25 | 25 | 25 | 25 | 20 |
| Zinc oxide | 2 | 2 | 2 | 2 | 2 | 2 | 2 |
| Stearic acid | 2 | 2 | 2 | 2 | 2 | 2 | 2 |
| Antioxidant | 2 | 2 | 2 | 2 | 2 | 2 | 2 |
| Wax | 2 | 2 | 2 | 2 | 2 | 2 | 2 |
| Resin | | | | | | | |
| Sulfur | 2.0 | 2.0 | 2.0 | 2.0 | 2.0 | 2.0 | 2.0 |
| Vulcanization accelerator CZ | 1.5 | 1.5 | 1.5 | 1.5 | 1.5 | 1.5 | 1.5 |
| Vulcanization accelerator DPG | 1.0 | 1.0 | 1.0 | 1.0 | 1.0 | 1.0 | 1.0 |
| St (%) in X | 20.5 | 17.6 | 7.2 | 2.8 | 12.8 | 6.3 | 6.3 |
| Evaluation (index) | | | | | | | |
| Low rolling resistance performance | 106 | 118 | 113 | 111 | 107 | 112 | 108 |
| Abrasion resistance performance | 105 | 109 | 114 | 117 | 104 | 109 | 105 |
| Chipping resistance performance | 107 | 114 | 123 | 121 | 118 | 125 | 129 |
| Tear resistance performance | 105 | 108 | 120 | 120 | 109 | 130 | 133 |

TABLE 3

| | Ex. 8 | Ex. 9 | Ex. 10 | Ex. 11 | Ex. 12 | Ex. 13 |
|---|---|---|---|---|---|---|
| Formulation | | | | | | |
| (parts by mass) | | | | | | |
| NR | 70 | 70 | 50 | 50 | 50 | 42 |
| SBR-1 | 10 | 10 | | | | |
| SBR-2 | | | | | | 58 |
| SBR-3 | 20 | 20 | 35 | 35 | 35 | |
| BR | | | 15 | 15 | 15 | |
| Carbon black | 5 | 5 | 10 | 5 | 20 | 10 |
| Silica-1 | 80 | 80 | 70 | 85 | 60 | |
| Silica-2 | | | | | | |
| Silica-3 | | | | | | 70 |
| Silane coupling agent | 7.5 | 7.5 | 7 | 8.5 | 6 | 7 |
| Oil | 30 | 25 | 25 | 30 | 30 | 25 |
| Zinc oxide | 2 | 2 | 2 | 2 | 2 | 2 |
| Stearic acid | 2 | 2 | 2 | 2 | 2 | 2 |
| Antioxidant | 2 | 2 | 2 | 2 | 2 | 2 |
| Wax | 2 | 2 | 2 | 2 | 2 | 2 |
| Resin | 5 | | 2 | 2 | 2 | |
| Sulfur | 2.0 | 2.0 | 2.0 | 2.0 | 2.0 | 2.0 |
| Vulcanization accelerator CZ | 1.5 | 1.5 | 1.5 | 1.5 | 1.5 | 1.5 |
| Vulcanization accelerator DPG | 1.0 | 1.0 | 1.0 | 1.0 | 1.0 | 1.0 |
| St (%) in X | 14.5 | 14.5 | 7.0 | 7.0 | 7.0 | 20.5 |
| Evaluation (index) | | | | | | |
| Low rolling resistance performance | 105 | 107 | 114 | 104 | 116 | 110 |
| Abrasion resistance performance | 104 | 103 | 112 | 106 | 106 | 108 |
| Chipping resistance performance | 105 | 104 | 125 | 111 | 128 | 106 |
| Tear resistance performance | 107 | 105 | 124 | 127 | 116 | 104 |

The results are as shown in Tables 1 to 3. In Comparative Example 1, because the styrene content in the other rubber component X was higher than 21 mass % although the amount of the natural rubber satisfied the specified range at around the lower limit value, the low rolling resistance performance and the abrasion resistance performance were poor. In Comparative Example 2, the styrene butadiene rubber in Comparative Example 1 was replaced with a butadiene rubber, and the chipping resistance performance and the tear resistance performance deteriorated although the abrasion resistance performance was improved.

In Comparative Example 3, the amount of the natural rubber was increased to 60 parts by mass compared to that of Comparative Example 1, and although the chipping resistance performance and the tear resistance performance improved, the abrasion resistance performance was poor because the styrene content in the other rubber component X was higher than 21 mass % as in Comparative Example 1.

In Comparative Example 4, the amount of the silica exceeded the upper limit value, and the abrasion resistance performance and the chipping resistance performance were poor. In Comparative Example 5, a thermoplastic resin was added compared to Comparative Example 4, and the chipping resistance performance was improved slightly but not satisfactory. In addition, the abrasion resistance performance and the low rolling resistance performance were poor.

In Comparative Example 6, because the amount of the natural rubber was lower than the specified amount although the styrene content in the other rubber component X was 21 mass % or less, the chipping resistance performance was inferior to that of Comparative Example 1.

In Comparative Example 7, although the chipping resistance performance and the tear resistance performance were superior to those of Comparative Example 1, because the amount of the natural rubber exceeded the specified amount, the effect of improving the low rolling resistance performance was not obtained, and the abrasion resistance performance was poor. In Comparative Example 8, a thermoplastic resin was added compared to Comparative Example 7, but no effect of improving the low rolling resistance performance and the abrasion resistance performance was observed.

In Comparative Example 9, because the amount of the silica was lower than the specified amount, the effect of improving the abrasion resistance performance was not obtained, and the tear resistance performance was poor, compared to those of Comparative Example 1. In Comparative Example 10, silica having a larger CTAB adsorption specific surface area than the specified value was used, and the low rolling resistance performance and the tear resistance performance were inferior to those of Comparative Example 1.

On the other hand, in Examples 1 to 13, the low rolling resistance performance, the abrasion resistance performance, the chipping resistance performance, and the tear resistance performance were all improved, and the performances were excellent, compared to those of Comparative Example 1.

Specifically, Examples 1 to 4 are examples in which the amount of the natural rubber was the same and in which the styrene content in the other rubber component X was decreased compared to those of Comparative Example 1. In Examples 1 to 4, the miscibility with the natural rubber improved as the styrene content in the other rubber component X became lower, and as a result, the effect of improving the abrasion resistance performance, the tear resistance performance, and the chipping resistance performance improved. Although the low rolling resistance performance was improved significantly compared to that of Comparative Example 1, the improvement effect did not increase when the styrene content was around 15 mass %, and the effect of improving the low rolling resistance performance of Example 4 was smaller than that of Example 2.

Examples 5 to 7 are examples in which the amount of the natural rubber was the same and in which the styrene content in the other rubber component X was decreased compared to those of Comparative Example 3. In Examples 5 to 7, because the styrene content in the other rubber component X was decreased, the miscibility with the natural rubber improved, and the abrasion resistance performance and the low rolling resistance performance were improved significantly while the chipping resistance performance and the tear resistance performance were maintained or improved, compared to those of Comparative Example 3.

Examples 8 and 9 are examples in which the amount of the natural rubber was the same and in which the amount of the silica was decreased to 80 parts by mass compared to those of Comparative Examples 4 and 5. In Examples 8 and 9, the low rolling resistance performance, the abrasion resistance performance, and the chipping resistance performance were improved significantly, and the four types of performance including the tear resistance performance were excellent, compared to those of Comparative Examples 4 and 5.

Examples 10 to 12 are examples in which the mass ratio NR/SBR/BR was 50/35/15 and in which the amount of the silica was changed in the specified range, and the low rolling resistance performance, the abrasion resistance performance, the chipping resistance performance, and the tear resistance performance were excellent with all the silica amounts.

Example 13 is an example in which the silica in Example 1 was replaced with silica having a small CTAB adsorption specific surface area, and the low rolling resistance performance, the abrasion resistance performance, the chipping resistance performance, and the tear resistance performance were excellent as in Example 1.

In this regard, the upper limits and the lower limits of the various numerical ranges described in the specification can be combined freely, and all the combinations should be regarded as being described as preferable numerical ranges in the present specification. Moreover, a numerical range “X to Y” means X or more and Y or less.

What is claimed is:

1. A rubber composition for a tire tread, comprising:
a rubber component containing a natural rubber and a styrene butadiene rubber; and
silica having a CTAB adsorption specific surface area of less than 200 m²/g:
wherein the amount of the natural rubber in 100 parts by mass of the rubber component is more than 40 parts by mass and less than 75 parts by mass,
the styrene content in the rubber component except for the natural rubber is 21 mass % or less, and
the amount of the silica is more than 55 parts by mass and less than 90 parts by mass based on 100 parts by mass of the rubber component.

2. The rubber composition for a tire tread according to claim 1, wherein 100 parts by mass of the rubber component contain more than 40 parts by mass and 60 parts by mass or less of the natural rubber, 15 parts by mass or more and less than 60 parts by mass of the styrene butadiene rubber, and 0 parts by mass or more and less than 45 parts by mass of a butadiene rubber.

3. The rubber composition for a tire tread according to claim 1, wherein the styrene butadiene rubber contains a modified styrene butadiene rubber.

4. The rubber composition for a tire tread according to claim 1, wherein the amount of the silica is 60 to 75 parts by mass based on 100 parts by mass of the rubber component.

5. The rubber composition for a tire tread according to claim 1 which further comprises 0.5 to 20 parts by mass of a thermoplastic resin based on 100 parts by mass of the rubber component.

6. A tire comprising a tread formed with the rubber composition for a tire tread according to claim 1.
